(19) United States
(12) Patent Application Publication
(10) Pub. No.: US 2025/0282298 A1
(43) Pub. Date: Sep. 11, 2025

(54) VEHICLE EQUIPMENT MOUNT

(71) Applicant: REALWHEELS CORPORATION, ZION, IL (US)

(72) Inventors: Cory L. POLKA, Green Oaks, IL (US); Ron TUSHNER, Spring Grove, IL (US); John G. POLKA, Green Oaks, IL (US)

(73) Assignee: REALWHEELS CORPORATION, ZION, IL (US)

(21) Appl. No.: 19/076,284

(22) Filed: Mar. 11, 2025

Related U.S. Application Data
(60) Provisional application No. 63/563,743, filed on Mar. 11, 2024.

(51) Int. Cl. B60R 9/06

(52) U.S. Cl. CPC B60R 9/06

(57) ABSTRACT

A vehicle equipment mount for a vehicle having a tow hook includes a clamp configured to mount on the tow hook, the clamp including a mounting surface for affixing vehicle equipment.

### CROSS REFERENCE TO RELATED APPLICATION

This application claims priority to U.S. Provisional Application, Ser. No. 63/563,743, filed on 11 Mar. 2024. This U.S. Provisional Application is hereby incorporated by reference herein in its entirety and is made a part hereof, including but not limited to those portions which specifically appear hereinafter.

### BACKGROUND OF THE INVENTION

### Field of the Invention

This invention relates generally to a mounting system for vehicle equipment, specifically a truck brush guard.

### Description of Prior Art

There is a substantial interest in the automotive aftermarket for modifications and similar improvements to vehicle appearance, utility and/or performance. More specifically, a need exists for automotive equipment that can be added to factory vehicles such as trucks and SUVs.

Often such aftermarket equipment requires substantial mechanical modifications, including welding and complex subframe assemblies, to facilitate additions such as racks, brush guards, tow packages and similar. Such substantial modifications may deter the casual user resulting in a potential loss of market.

A need therefore exists in the automotive aftermarket, specifically in trucks and SUVs, for a simple, safe and reliable modification platform to facilitate the addition of aftermarket equipment. Although the focus of the subject invention is on aftermarket equipment, the subject invention is equally applicable to the original equipment manufacturer (OEM).

### SUMMARY OF THE INVENTION

The invention generally relates to a mounting system that utilizes OEM tow hooks as a platform for mounting aftermarket equipment, such as a brush guard.

Other objects and advantages will be apparent to those skilled in the art from the following detailed description taken in conjunction with the appended claims and drawings.

### BRIEF DESCRIPTION OF THE DRA WINGS

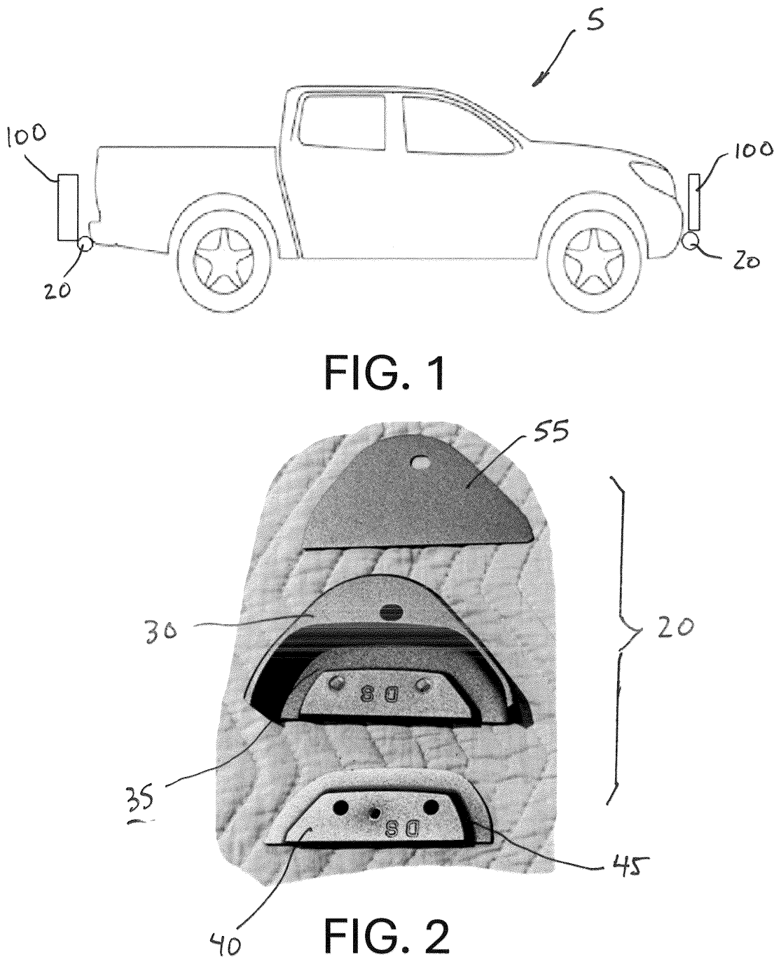

FIG. 1 shows a schematic of a vehicle according to one preferred embodiment;

FIG. 2 shows an exploded top view of a clamp according to one preferred embodiment;

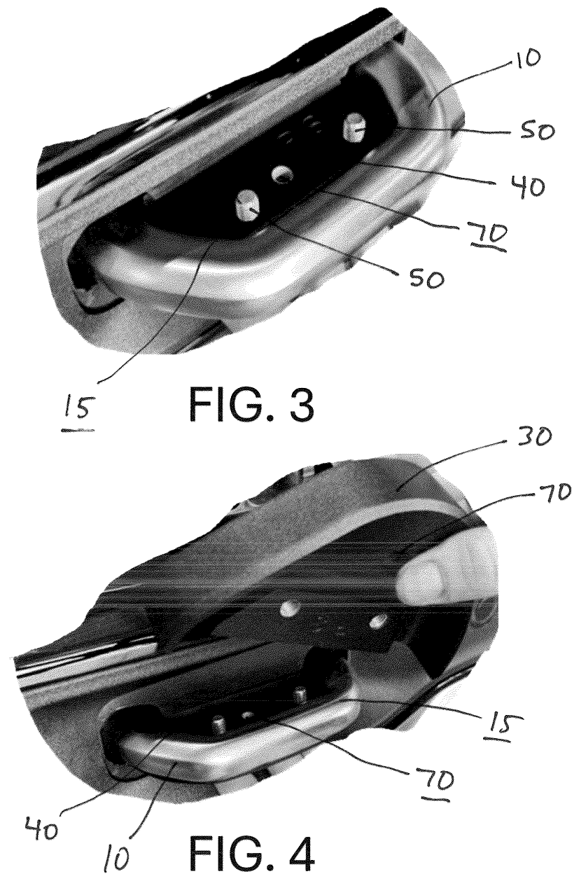

FIG. 3 shows a front perspective view of a tow hook and fastener plate according to one preferred embodiment;

FIG. 4 shows a front perspective view of a tow hook, cover, and fastener plate according to one preferred embodiment;

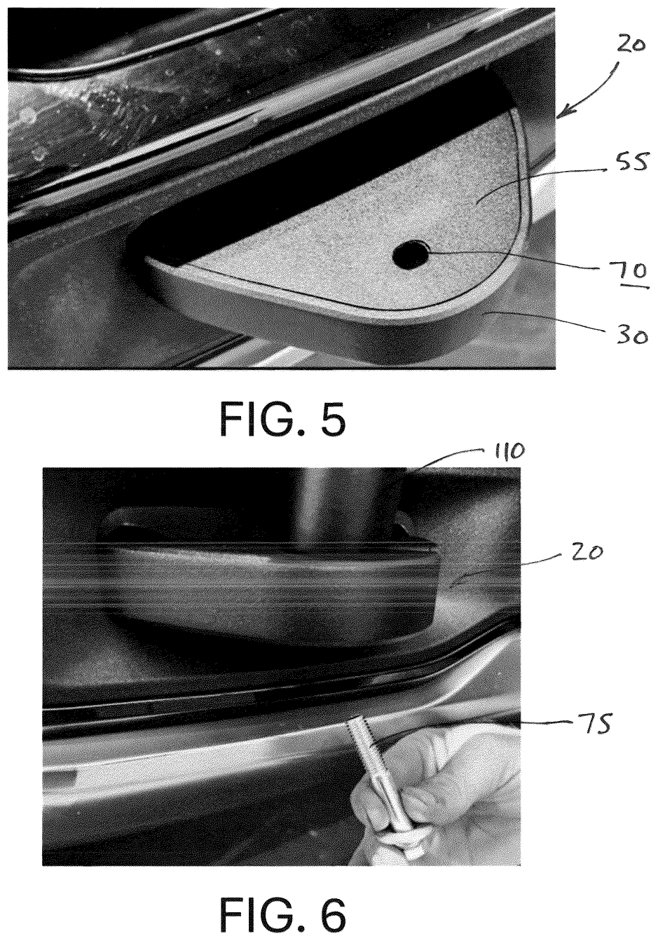

FIG. 5 shows a front perspective view of a tow hook and assembled clamp according to one preferred embodiment;

FIG. 6 shows a front perspective view of a tow hook and clamp with vehicle equipment according to one preferred embodiment;

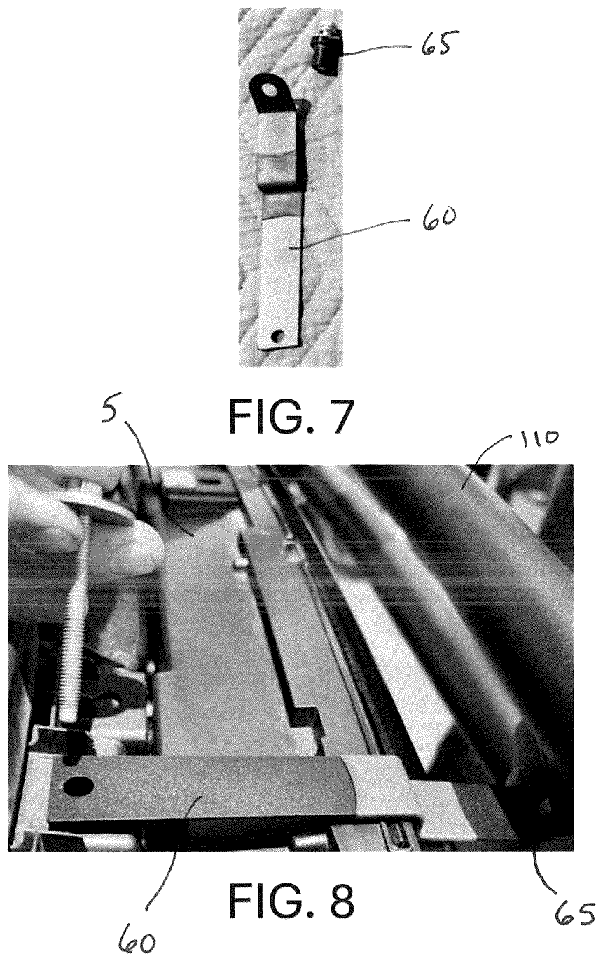

FIG. 7 shows a top view of a support strap and insulating nut according to one preferred embodiment;

FIG. 8 shows a front perspective view of a support strap connected to a vehicle and the vehicle equipment according to one preferred embodiment;

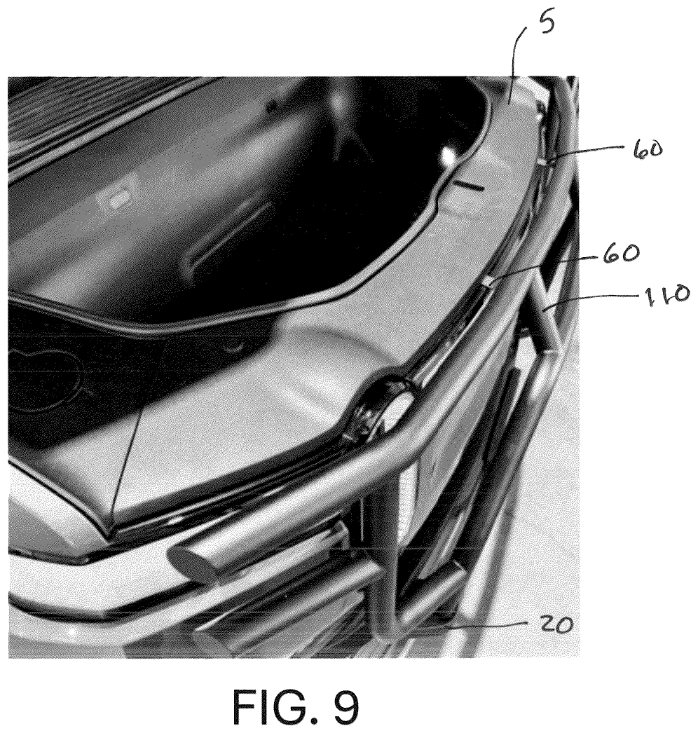

FIG. 9 shows a side perspective view of a brush guard according to one preferred embodiment;

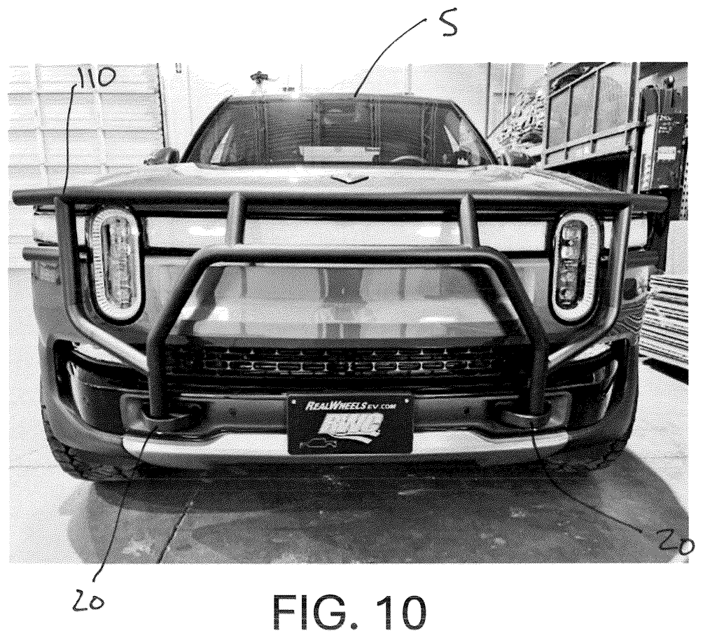

FIG. 10 shows a front view of the brush guard shown in FIG. 9;

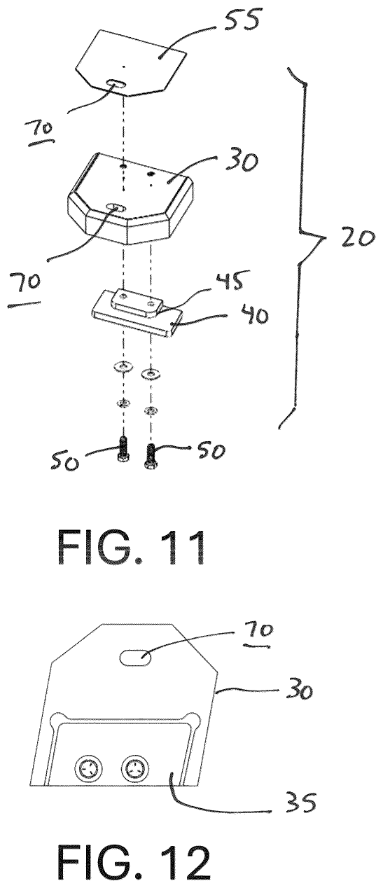

FIG. 11 shows a side perspective exploded view of a clamp according to one embodiment; and

FIG. 12 shows a bottom view of a cover shown in the clamp in FIG. 11.

### DETAILED DESCRIPTION OF THE INVENTION

The present invention provides a system for mounting vehicle equipment 100 to a vehicle 5 such as shown schematically in FIG. 1. Vehicle equipment 100 may include such things as a brush guard 110, light bar, storage rack, winch, hitch mount, flag mount, bull bars, bike rack, spare tire holder, auxiliary lighting, jack mount, a luggage rack and/or other mountable vehicle components, accessories, and mounts. As shown in the drawings, and for the purposes of the specification, the following description is directed to an embodiment including a brush guard 110 although any of the above options is represented schematically in FIG. 1. It is noted that the described system may be configured for attachment to the front and/or rear of a vehicle 5. The subject brush guard 110 embodiment is intended for use in the front of the vehicle 5.

Many vehicles, particularly heavy duty and work use vehicles such as pickup trucks, include integrated tow hooks 10 that are generally used to attach chains or tow straps for use to tow the vehicle or another out of snow, mud or terrain. Such tow hooks 10 are also used to pull or move heavy objects, again with a chain, rope or strap. Lastly, such tow hooks 10 may be used by towing vehicles to winch the vehicle onto a flatbed or into position for a tow. These tow hooks 10 may be oriented vertically or horizontally and may be attached to the front and/or rear of the vehicle. One commonality of all applications is that the tow hook 10 includes some sort of central aperture 15. In addition, tow hooks 10 are generally anchored to a frame of the vehicle to provide sufficient strength and rigidity for the various requirements.

As shown in FIGS. 1-12, the subject system may include one and preferably two clamps 20 each for mounting to a corresponding tow hook 10 in the front or rear of the vehicle. As shown in FIG. 2, the clamps 20 preferably include a two-piece clamshell design that sandwiches around a corresponding tow hook 10 and further includes a mounting surface and/or a mounting aperture for affixing vehicle equipment 100.

As shown in the figures, the vehicle equipment mount includes a pair of clamps 20 and a pair of tow hooks 10, so that each clamp 20 of the pair of clamps 20 mounts to a separate tow hook 10. As shown in FIG. 2, each clamp 20 preferably includes a cover 30 and a fastener plate 40 wherein the cover 30 and the fastener plate 40 form a clamshell around the tow hook 10. In addition, each clamp 20 may further include a contact plate 55.

FIGS. 3 and 4 show one preferred embodiment of the clamp 20 wherein the cover 30 overlays the tow hook 10 and the fastener plate 40 fits through or within the aperture 15 of the tow hook 10. One or more fastening bolts may be used to connect the fastener plate 40 to the cover 30 around and/or through the tow hook 10. As shown in FIG. 5, a contact plate 55 may be attached to the cover 30 and may fit flush within a shallow pocket on the cover 30. The contact plate 55 preferably provides a smooth finished surface for affixing the vehicle equipment 100.

In addition, and as best shown in FIGS. 2, 11 and 12, the fastener plate 40 may be contoured to fit within a cavity 35 in the cover 30. Preferably this contour is asymmetrical across the fastener plate 40 such that the fastener plate 40 is engageable and connectable with the cover 30 in only a single alignment. This arrangement prevents user error in attaching the clamps 20 to the tow hooks 10 by ensuring correct placement and alignment of each clamp 20.

FIG. 6 shows attachment of the vehicle equipment 100, in this case a brush guard 110, with a connecting bolt 75. To accommodate this attachment, the cover 30 and/or the fastener plate 40 and/or the contact plate 55 include a through hole 70 configured to mount the vehicle equipment 100 such as with one or more bolts 75 or other connectors.

In the embodiment shown in the drawings wherein a brush guard 110 is attached to the vehicle, and as specifically shown in FIGS. 7 and 8, at least one support strap 60 is used to provide a second axis of connection between the brush guard 110 and the vehicle. The vehicle equipment 100, such as brush guard 110, is preferably attached at each clamp 20 and further attached to a second mounting point on the vehicle. As such, the support strap 60 may extend between an upper surface of the brush guard 110 and a second mounting point on the vehicle, specifically within the engine bay as shown in FIG. 8. In addition, the support strap 60 may be attached at the second mounting point with a insulating nut 65 as shown in FIG. 7. The insulating nut 65 preferably includes a rubberized grommet or insert to isolate the attachment point and reduce possible vibration.

According to one embodiment of the subject invention (not shown), the vehicle equipment mount may include a single structural clamp 20 that extends between and affixes to two tow hooks 10. Such an arrangement may be helpful for accessories or equipment that requires an even greater structural support.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

1. A vehicle equipment mount for a vehicle having a tow hook, the vehicle equipment mount comprising:
a clamp configured to mount on the tow hook, the clamp including a mounting surface for affixing vehicle equipment.

2. The vehicle equipment mount of claim 1 further comprising at least one support strap extending between the vehicle equipment and a second mounting point on the vehicle.

3. The vehicle equipment mount of claim 1 comprising a pair of clamps and a pair of tow hooks, each clamp of the pair of clamps mounting to a separate tow hook.

4. The vehicle equipment mount of claim 1 wherein the clamp comprises a cover and a fastener plate wherein the cover and the fastener plate form a clamshell around the tow hook.

5. The vehicle equipment mount of claim 4 wherein the cover overlays the tow hook and the fastener plate fits within an aperture of the tow hook.

6. The vehicle equipment mount of claim 5 further comprising at least one bolt connecting the fastener plate to the first portion around and through the tow hook.

7. The vehicle equipment mount of claim 4 wherein the cover and the fastener plate include a through hole configured to mount the vehicle equipment.

8. The vehicle equipment mount of claim 4 wherein the fastener plate is contoured to fit within a cavity in the cover.

9. The vehicle equipment mount of claim 8 wherein the contour is asymmetrical across the fastener plate and is configured to engage with the cover in a single alignment.

10. The vehicle equipment mount of claim 1 further comprising a brush guard mounted to the clamp.

11. The vehicle equipment mount of claim 10 further comprising a strap connecting a top portion of the brush guard to the vehicle.

12. The vehicle equipment mount of claim 1 wherein the vehicle equipment comprises at least one of a winch, a hitch mount, a flag mount, bull bars, a bike rack, a spare tire holder, auxiliary lighting, a jack mount, and a luggage rack.

13. The vehicle equipment mount of claim 1 wherein the clamp affixes to two tow hooks.

14. A vehicle equipment mount for a vehicle having a tow hook, the vehicle equipment mount comprising:
a pair of clamps configured to mount on a pair of tow hooks, the clamps each including a mounting surface for affixing vehicle equipment, a cover, and a fastener plate wherein the cover and the fastener plate form a clamshell around the tow hook; and
at least one support strap extending between the vehicle equipment and a second mounting point on the vehicle.

15. The vehicle equipment mount of claim 14 wherein the cover overlays the tow hook and the fastener plate fits within an aperture of the tow hook.

16. The vehicle equipment mount of claim 15 further comprising at least one bolt connecting the fastener plate to the first portion around and through the tow hook.
